(19) United States
(12) Patent Application Publication
(10) Pub. No.: US 2019/0032866 A1
(43) Pub. Date: Jan. 31, 2019

(54) LIGHT EMITTING DEVICE AND ILLUMINATING APPARATUS

(71) Applicant: SHARP KABUSHIKI KAISHA, Sakai City, Osaka (JP)

(72) Inventors: KAZUNORI ANNEN, Sakai City (JP); KOJI TAKAHASHI, Sakai City (JP); YOSHINOBU KAWAGUCHI, Sakai City (JP); YOSUKE MAEMURA, Sakai City (JP); TOMOHIRO SAKAUE, Sakai City (JP); YOSHIYUKI TAKAHIRA, Kizugawa City, Kyoto (JP)

(21) Appl. No.: 16/073,263

(22) PCT Filed: Dec. 20, 2016
(86) PCT No.: PCT/JP2016/087912

§ 371 Date: Jul. 26, 2018

(30) Foreign Application Priority Data
Jan. 26, 2016 (JP) 2016-012689

(51) Int. Cl. F21K 9/65; F21K 9/64; F21K 9/68; F21S 41/141; F21S 41/16; F21S 43/20; F21V 9/30

(52) U.S. Cl. CPC F21K 9/65; F21K 9/64; F21K 9/68; F21V 9/30; F21S 41/16; F21S 43/20; F21S 41/141

(57) ABSTRACT

Efficiency of extracting fluorescent light in a desired direction is improved. A light emitting portion (12) of a light emitting device (10) includes a gap present inside thereof, the gap having a width that is one-tenth or less of the wavelength of laser light. An excitation-light transmitting film (13) that transmits laser light and that reflects fluorescent light is provided on a side where a light reception surface (12a) that receives laser light is present. A fluorescent-light transmitting film (14) that reflects laser light and that transmits fluorescent light is provided on a side where an emission surface (12b) that emits fluorescent light is present.

### TECHNICAL FIELD

The present disclosure relates to a light emitting device and the like.

### BACKGROUND ART

In recent years, active research has been made on a light emitting device that uses, as excitation light sources, semiconductor light-emitting elements such as light emitting diodes (LED) or semiconductor lasers (laser diodes (LDs)) and uses, as illumination light, fluorescent light that is generated by irradiating a light emitting portion containing phosphors with excitation light generated from these excitation light sources. An example of such a light emitting device is presented in each of Patent Literatures (PTLs) 1 to 3.

In the light emitting device described in PTL 1, a wavelength converting member is provided with a reflecting member that reflects at least a portion of light emitted from the wavelength converting member and excitation light; and a blocking member that blocks at least a portion of the light and the excitation light. When the reflecting member is an excitation-light reflecting member capable of transmitting only wavelength-converted light that has a specific wavelength and capable of reflecting excitation light, the reflecting member is disposed at a wavelength-converted light deriving portion of the wavelength converting member. When the reflecting member is a wavelength-converted light reflecting member capable of transmitting only light that has a specific wavelength and capable of reflecting the wavelength-converted light, the reflecting member is disposed at an excitation-light introducing portion of the wavelength converting member.

PTL 2 discloses a light source device in which a reflection-type polarized light separating element that reflects light having a polarization direction different from a polarization direction of incident excitation light is provided on an excitation light incident side of a phosphor layer.

In the illuminating apparatus described in PTL 3, an ultraviolet light-reflecting layer that reflects ultraviolet light and transmits visible light is provided on a side, where an emission surface that transmits visible light is present, of a phosphor layer that contains fluorescent substances that emit light by receiving ultraviolet light. In addition, the phosphor layer has an incident surface on which ultraviolet light is incident. A visible-light reflecting layer that reflects visible light and transmits ultraviolet light is provided on a side of the phosphor-layer where an incident surface on which ultraviolet light is incident is present. In the phosphor layer, the fluorescent substances are dispersed. Consequently, light emission occurs throughout the phosphor layer, and visible light generated as a result of the light emission travels isotropically.

### CITATION LIST

### Patent Literature

PTL 1: Japanese Unexamined Patent Application Publication No. 2007-220326, laid open on Aug. 30, 2007

PTL 2: Japanese Unexamined Patent Application Publication No. 2012-209228, laid open on Oct. 25, 2012

PTL 3: Japanese Unexamined Patent Application Publication No. 2007-227320, laid open on Sep. 6, 2007

### SUMMARY OF INVENTION

### Technical Problem

In the light emitting device described in PTL 1, for the purpose of transmitting only light having a specific wavelength, at least a portion of excitation light or fluorescent light is blocked. In other words, in the light emitting device, the blocking member: and the reflecting member are provided not for easy transmission of fluorescent-light; thus, there is a possibility that fluorescent-light extraction efficiency is decreased.

In the light source device in PTL 2, the reflection-type polarized light separating element returns, to the inside of the phosphor layer, excitation light that has been changed in terms of the polarization direction after being made incident on the phosphor layer. However, the reflection-type polarized light separating element transmits excitation light (excitation light having the same polarization direction as that of the excitation light before being made incident on the phosphor layer) that has not been changed in terms of the polarization, direction after being made incident on the phosphor layer. Thus, there is a possibility that the excitation light is emitted toward, the excitation, light source without returning to the inside of the phosphor layer. In this case, the excitation light that has been emitted toward the excitation light source is not possible to excite the phosphor layer, and it is not possible to extract fluorescent light from the emission surface of the phosphor layer.

Therefore, in each of the devices according to PTLs 1 and 2, there is a possibility that fluorescent-light extraction efficiency is decreased.

When phosphors in which Mie scattering does not easily occur are used in the wavelength converting member or the phosphor layer, a travelling direction of fluorescent light emitted due to the excitation light does not change, and the fluorescent light emitted in all directions from the phosphors travels in the all directions as it is. Thus, in this case, there is a possibility that efficient extraction of the fluorescent light in a desired direction (for example, toward the fluorescent light emission surface, which faces an excitation-light reception surface, of the wavelength converting member or the phosphor layer) becomes difficult,

PTLs 1 and 2 include no mention relating to a phosphor structure in which Mie scattering does not occur and naturally, include no mention relating to fluorescent-light extraction considering the use of the phosphors in which Mie scattering does not easily occur. Moreover, the fluorescent substances are scattered in the phosphor layer in PTL 3. In other words, Mie scattering easily occurs throughout the structure of the phosphor layer. Thus, PTL 3 also includes no mention relating to fluorescent-light extraction considering the use of the phosphors in which Mie scattering does not easily occur.

The present disclosure has been made considering the aforementioned problems, and a purpose of the disclosure is to provide a light emitting device and an illuminating apparatus capable of improving efficiency of extracting fluorescent light in a desired direction.

### Solution to Problem

To solve the aforementioned problems, a light emitting device according to one aspect of the present invention includes a small-gap fluorescent member that emits fluorescent light by receiving excitation light emitted from an excitation light source. The small-gap fluorescent member includes a gap present inside thereof, the gap having a width that is one-tenth or less of a wavelength of the excitation light; and a light reception surface that receives the excitation light and an emission surface that is opposite to the light reception surface and that emits the fluorescent light. An excitation-light transmitting member is provided on a side where the light reception surface is present. The excitation-light transmitting member transmits the excitation light and reflects the fluorescent light, A fluorescent-light transmitting member is provided on a side where the emission surface is present. The fluorescent-light transmitting member reflects the excitation light and transmits the fluorescent light.

### Advantageous Effects of Invention

According to one aspect of the present invention, an effect in which it is possible to improve efficiency of extracting fluorescent light in a desired direction is exhibited.

### BRIEF DESCRIPTION OF DRAWINGS

FIG. 1 is a schematic view illustrating a configuration of a light emitting device according to a first embodiment of the present invention.

FIG. 2 is a sectional view illustrating a configuration of an illuminating apparatus including the light emitting device according to the first embodiment of the present invention.

FIG. 3 is a schematic view illustrating a gap width in a small-gap phosphor plate.

FIG. 4(a) is a graph showing a simulation result of the transmittance of light vertically incident on an excitation-light transmitting film.

FIG. 4(b) is a graph showing a simulation result of the reflectance of light vertically incident on the excitation-light transmitting film.

FIG. 4(c) is a graph showing, for each wavelength, a simulation result of the transmittance of light incident on the excitation-light transmitting film.

FIG. 5(a) is a graph showing a simulation result of the transmittance of light vertically incident on a fluorescent-light transmitting film.

FIG. 5(b) is a graph showing a simulation result of the reflectance of light vertically incident on the fluorescent-light transmitting film.

FIG. 5(c) is a graph showing, for each wavelength, a simulation result of the transmittance of light incident on the fluorescent-light transmitting film.

FIG. 6(a) is an illustration of the behavior of excitation light in a light emitting device of a comparative example.

FIG. 6(b) is an illustration of the behavior of excitation light in the light emitting device according to the first embodiment.

FIG. 6(c) is an illustration of the behavior of fluorescent light in the light emitting device of the comparative example.

FIG. 6(d) is an illustration of the behavior of fluorescent light in the light emitting device according to the first embodiment.

FIG. 7 is a graph showing the fluorescent-light transmittance of an emission surface of a light emitting portion.

FIG. 8 is a schematic view illustrating a structure of a light emitting device according to a second embodiment of the present invention.

FIG. 9 is a schematic view illustrating a structure of a light emitting device according to a third embodiment of the present invention.

FIG. 10 is a schematic view illustrating a structure of a light emitting device according to a fourth embodiment of the present invention.

FIG. 11 is a schematic view illustrating a structure of a light emitting device according to a fifth embodiment.

FIG. 12 is a schematic view illustrating a structure of a light emitting device according to a sixth embodiment of the present invention.

### DESCRIPTION OF EMBODIMENTS

### First Embodiment

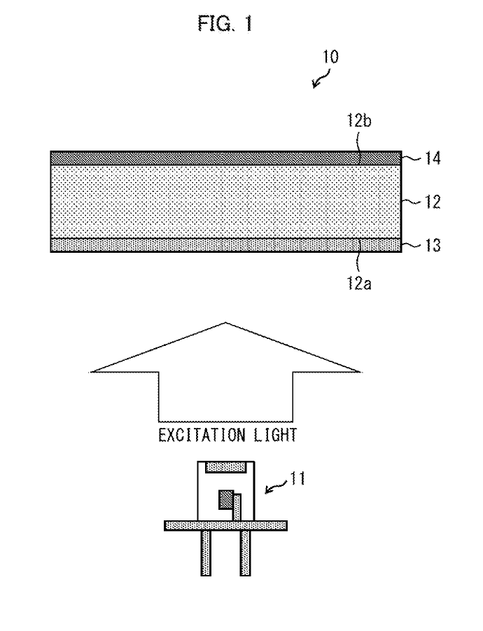

Hereinafter, an embodiment of the present invention will be described with reference to FIGS. 1 to 7.

<<Illuminating Apparatus 1>>

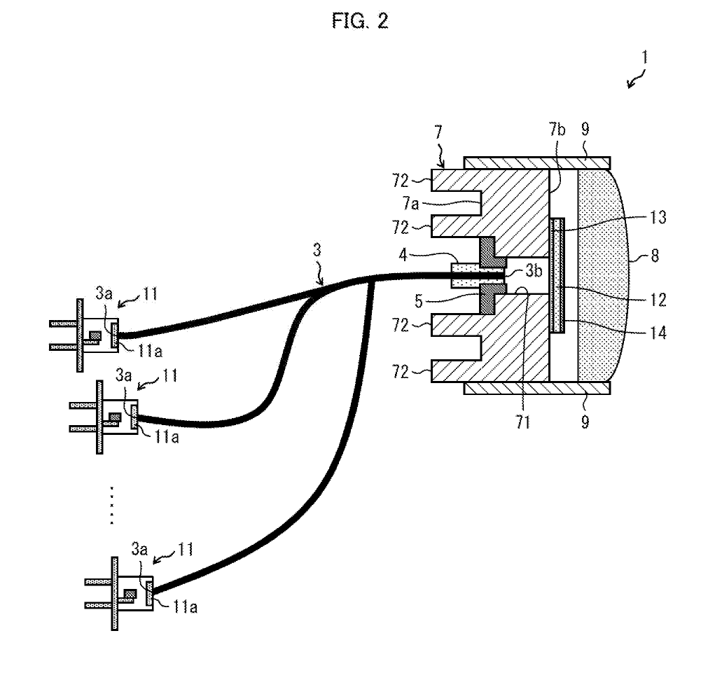

FIG. 2 is a sectional view illustrating a configuration of an illuminating apparatus 1 that includes a light emitting device 10 according to the present embodiment. As illustrated in FIG. 2, the illuminating apparatus 1 includes optical fibers 3, a ferrule 4, a ferrule fixing portion 5, a metal base 7, a light-projecting lens 8 (light-projecting member), a lens fixing portion 9, laser elements 11 (excitation light sources), a light emitting portion 12, an excitation-light transmitting film 13, and a fluorescent-light transmitting film 14. Among these, the laser elements 11, the light emitting portion 12, the excitation-light transmitting film 13, and the fluorescent-light transmitting film 14 constitute the light emitting device 10 (refer to FIG. 1). The light emitting device 10 will be described later.

<Optical Fibers 3>

The optical fibers 3 are light-guiding members that guide laser light (described later) emitted from the laser elements 11. In the present embodiment, the optical fibers 3 are a bundle fiber that includes a plurality of optical fiber s bundled together.

Each optical fiber 3 includes an incident end portion 3a on which laser light is incident and an emission end portion 3b from which the laser light incident on the incident end portion 3a is emitted. The incident end portions 3a are connected to the laser elements 11 corresponding thereto. The emission end portions 3b are held by the ferrule 4 and connected to the metal base 7 via the ferrule fixing portion 5.

<Ferrule 4>

The ferrule 4 is a holding member that holds the emission end portions 3b of the optical fibers 3. The ferrule 4 is attached to a side of the optical fibers 3 where the emission end portions 3b are present. The ferrule 4 is, for example, a ferrule in which a plurality of holes into which the emission end portions 3b are insertable are formed.

The ferrule 4 may be omitted when a single optical fiber 3 is used. However, even when the single optical fiber 3 is used, the ferrule 4 is preferably provided to fix the emission end portion 3b to an appropriate position.

<Ferrule Fixing Portion 5>

The ferrule fixing portion 5 is a fixing member that fixes the ferrule 4 to the metal base 7. The ferrule fixing portion 5 is a cylindrical member that has light-shielding properties. The ferrule fixing portion 5 is intruded from one end of an excitation-light passing hole 71 formed in the metal base 7 in the thickness direction thereof and fixed to the metal base 7. The ferrule fixing portion 5 fixes the ferrule 4 to the metal base 7 at an angle that enables the laser light emitted from the emission end portion 3b of each optical fiber 3 to irradiate appropriately the light emitting portion 12 disposed at the other end of the excitation-light passing hole 71.

The ferrule fixing portion 5 is preferably a member that does not absorb light and preferably formed of, for example, aluminum.

<Metal Base 7>

The metal base 7 is a supporting member that supports the light emitting portion 12. The metal base 7 is formed of metal (for example, aluminum, copper, iron, or the like). Thus, the metal base 7 has high heat conductivity and is capable of efficiently dissipating the heat generated in the light emitting portion 12.

The metal base 7 has the excitation-light passing hole 71 that extends through the center portion of the metal base 7 in the thickness direction (left-right direction in the sheet of FIG. 1). One end of the excitation-light passing hole 71 is open at a rear surface 7a of the metal base 7. The other end of the excitation-light passing hole 71 is open at a front surface 7b of the metal base 7.

The emission end portions 3b of the optical fibers 3 are disposed at an open portion on the one end (rear surface 7a of the metal base 7) of the excitation-light passing hole 71. The light emitting portion 12 is disposed at an open portion on the other end (front surface 7b of the metal base 7) of the excitation-light passing hole 71 so as to cover the open portion. Thus, the laser light emitted from the emission end portion 3b of each optical fiber 3 passes through the excitation-light passing hole 71 of the metal base 7 and irradiates the light emitting portion 12.

The metal base 7 dissipates, via heat dissipation fins 72 and the like, the heat generated in the light emitting portion 12. A plurality of the heat dissipation fins 72 are disposed on the rear surface 7a of the metal base 7 and function as a heat dissipation mechanism that dissipates heat of the metal base 7 into air.

The neat dissipation efficiency of the heat dissipation fins 72 is increased by increasing a contact area thereof with air. The heat dissipation fins 72 are preferably formed of a material having high heat conductivity as is the metal base 7.

<Light-Projecting Lens 8>

The light-projecting lens 8 is an optical member that projects illumination light containing the laser light and the fluorescent light emitted from the light emitting portion 12. The light-projecting lens 8 projects the illumination light in a prescribed angular range by refracting the illumination light containing the laser light and the fluorescent light emitted from the light emitting portion 12.

The light-projecting lens 8 is formed of, for example, an acrylic resin, polycarbonate, silicone, borosilicate glass, BK7, or quarts. The light-projecting lens 8 is supported at a position opposite the light emitting portion 12 by the lens fixing portion 9.

The number of the light-projecting lens 8 may be one or may be two or more. The light-projecting lens 8 may be in a shape of an aspherical lens or a spherical lens. The number and the shape of the light-projecting lens 8 to be used are; selected as necessary and as appropriate.

<Lens Fixing Portion 9>

The lens fixing portion 9 is a fixing member that fixes the light-projecting lens 8 to the metal base 7. The lens fixing portion 9 is a cylindrical member having light-shielding properties. The lens fixing portion 9 holds, at an inner surface thereof, the peripheral surface of the metal base 7 and the peripheral surface of the light-projecting lens 8. The use of the lens fixing portion 9 enables the illumination light that contains the laser light and the fluorescent light emitted from the light emitting portion 12 to be incident on the light-projecting lens 8 without leaking to the outside.

The lens fixing portion 9 is preferably formed of a material having high heat dissipation properties. In particular, anodized aluminum may be suitably used.

<<Light Emitting Device 10>>

FIG. 1 is a schematic: view illustrating a configuration of the light emitting device 10 according to the present embodiment. As illustrated in FIG. 1, the light emitting device 10 includes the laser elements 11, the light emitting portion 12 (small-gap fluorescent member), the excitation-light transmitting film 13 (excitation-light transmitting member), and the fluorescent-light transmitting film 14 (fluorescent-light transmitting member). Note that in the following description, the laser elements 11 will be described as a part of the light emitting device 10. However, main parts of the light emitting device 10 are the light emitting portion 12, the excitation-light transmitting film 13, and the fluorescent-light transmitting film 14.

<<Laser Elements 11>>

The laser elements 11 are excitation light sources that emit laser light (excitation light). As illustrated in FIG. 2, in the present embodiment, the light emitting device 10 is provided with a plurality of the laser elements 11. However, in FIG. 1, only one of the laser elements 11 is illustrated for simplicity. The laser light emitted from each of the laser elements 11 is spatially and temporally uniform in terms of phase and has a single wavelength. Thus, the use of the laser light as the excitation light enables the light emitting portion 12 to be efficiently excited, which makes it possible to obtain illumination light having high luminance.

In the laser elements 11, the wavelength and the optical output power of the laser light to be emitted are set, as appropriate, depending on the type of the phosphors that form the light emitting portion 12. For example, it is possible to select, as excitation light, laser light having a wavelength in the range of 420 nm or more and less than 455 nm.

The laser light emitted from each of the plurality of laser elements 11 is incident on the incident end portions 3a of the optical fibers 3 and emitted from the emission end portions 3b that are positioned opposite to the incident end portions 3a, and irradiates the light emitting portion 12. A portion of the laser light that irradiates the light-emitting portion 12 is converted into fluorescent light by phosphors that form the light emitting portion 12.

When the laser light emitted from each laser element 11 is made incident on the incident end portions 3a of the optical fibers 3, an aspherical lens 11a is preferably used so that the laser light is appropriately incident on the incident end portions 3a. The aspherical lens 11a is preferably formed of a material that has high transmittance with respect to the laser light emitted from each laser element 11 and that has excellent heat resistance.

The number of the laser elements 11 to be used may be selected, as appropriate, depending on required output power. Thus, only one of the laser elements 11 may be used. However, when it is required to obtain laser light having high output power, a plurality of the laser elements 11 are preferably used as in the present embodiment.

As an alternative to the laser elements 11, for example, light-emitting diodes may be provided as excitation light sources. The type of the excitation light sources is not limited as long as the excitation light sources emit excitation light capable of exciting the phosphors that form the light emitting portion 12.

<Light Emitting Portion 12>

The light emitting portion 12 emits fluorescent light by receiving the laser light emitted from each laser element 11. The light emitting portion 12 has a light reception surface 12a that receives laser light and an emission surface 12b that is opposite to the light reception surface 12a and that emits fluorescent light.

The light emitting portion 12 is preferably formed of a garnet-based small-gap phosphor plate. The small-gap phosphor plate means a phosphor plate in which the width (hereinafter, referred to as the gap width) of each gap present in the phosphor plate is one-tenth or less of the wavelength of visible light. Specifically, the small-gap phosphor plate means a phosphor plate in which the gap width is 0 nm or more and 40 nm or less. Namely, when the gap width is represented by the symbol t, 0 nm≤t≤40 nm. The “small-gap phosphor plate” may be referred to as “small-gap fluorescent member”.

It should be noted that the meaning of the term, “small-gap phosphor plate” includes, not only a phosphor plate in which gaps are present (0 nm<t<40 nm), but also a phosphor plate in which no gap is present (t=0 nm). Namely, in one aspect of the present invention, the meaning of the wording “small gap” includes “no gap is present”.

Moreover, the aforementioned “gap” means a gap (in other words, a grain boundary) between crystals in the phosphor plate. An example of the gap is a cavity in which only air is present inside. However, some sorts of foreign substances may be included inside the gap.

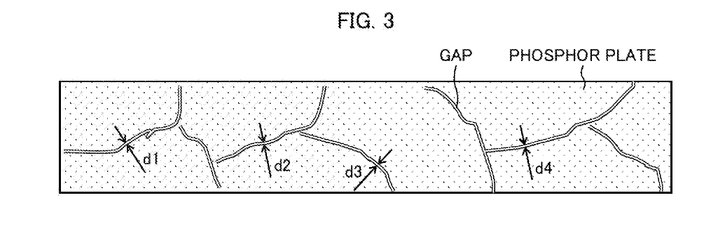

In addition, the aforementioned “gap width” means a maximum value of a distance between adjacent crystals (crystal grains) in the phosphor plate. FIG. 3 is a schematic view illustrating the gap width in the small-gap phosphor plate. In FIG. 3, distances d1 to d4 are indicated as distances between adjacent crystals. For example, when the distance d1, among the distances d1 to d4, is the maximum distance, the distance d1 is the gap width.

In order to measure the aforementioned distances d1 to d4, after a sectional surface of the phosphor plate is formed by cutting, an observed image of the sectional surface is obtained by using a measuring apparatus such as an optical microscope, a SEM (scanning electron microscope), or a TEM (transmission electron microscope). It is possible to measure the distances d1 to d4 by analyzing the observed image. That is, it is possible to measure the gap width.

The small-gap phosphor plate has excellent heat conductivity because the gap width thereof is 0 nm≤t≤40 nm. Thus, even when, the light emitting portion 12 is irradiated with high-density laser light, the temperature of the light emitting portion 12 is not easily increased, and light emission efficiency is not easily decreased. Therefore, it is possible to provide the light emitting portion 12 having high luminance and high efficiency by using the small-gap phosphor plate as the light emitting portion 12.

In particular, the small-gap phosphor plate (monocrystalline phosphor plate) in which the gap width is t=0 has excellent crystal Unity (less defects) and thus has excellent temperature characteristic. Therefore, the light emission efficiency is not easily decreased even when the temperature is increased. Accordingly, the small-gap phosphor plate in which the gap width is t=0 is preferably used as the light emitting portion 12; and consequently, it is possible to suitably provide the light emitting portion 12 having high luminance and high efficiency.

When the small-gap phosphor plate is formed of polycrystalline phosphors, a phosphor raw material powder is first obtained by using a submicron-sized oxide powder, as a raw material, by a liquid phase method or a solid phase method. For example, when the phosphor raw material powder is a YAG:Ce phosphor, the aforementioned oxide is an yttrium oxide, an aluminum oxide, a cerium oxide, and the like. Then, the phosphor raw material powder is molded in, for example, a metal mold and sintered in vacuum.

By using the aforementioned method, it is possible to obtain the small-gap phosphor plate in which the gap width is more than 0 nm and 40 nm or less (that is, 0 nm<t≤40 nm). The small-gap phosphor plate has high heat conductivity because the gap width is narrow. Therefore, the temperature of the small-gap phosphor plate is not easily increased even when the small-gap phosphor is irradiated with high-density excitation light. Accordingly, it is possible to provide the light emitting portion 12 having high luminance and high efficiency by using, as the light emitting portion 12, the small-gap phosphor plate formed of polycrystalline phosphors because it is possible to suppress a decrease in the light emission efficiency of the light emitting portion 12. Moreover, in this case, it is possible to reduce a material loss during processing after sintering and a time required for the processing because the light emitting portion 12 is sintered in a state of being molded into a shape similar to a shape employed in a product.

An example of a method of producing the small-gap phosphor plate in the case in which the small-gap phosphor plate is formed of monocrystalline phosphors is a liquid phase method, for example, a CZ (Czochralski) method. Specifically, an oxide powder is first subjected to dry blending into a mixed powder, and the mixed powder is put in a crucible and heated to obtain a melt. Next, seed crystals (for example, YAG monocrystals in the case of YAG) of the phosphors are prepared, and after the seed crystals are; brought into contact with the melt, the seed crystals are pulled up while being rotated. The temperature during pulling-up is approximately 2000° C. Consequently, it is possible to grow a monocrystalline ingot in a <111> direction. Then, the ingot is cut to a desired size. At this time, depending on the manner of cutting, it is possible to obtain a monocrystalline ingot in a direction of, for example, <001> or <110>.

The monocrystalline ingot obtained by the aforementioned method includes no gap (that is, t=0). Therefore, heat conductivity is further increased (approximately 10 W/m·K) compared with the small-gap phosphor plate formed of polycrystalline phosphors. Thus, the temperature of the small-gap phosphor plate is not easily increased when the small-gap phosphor plate is irradiated with high-density excitation light. Therefore, it is possible to provide the light emitting portion 12 in which luminance and efficiency are further increased by using, as the light emitting portion 12, the small-gap phosphor plate formed of the monocrystalline phosphors. Moreover, according to the aforementioned method, the monocrystalline ingot is obtained from, the melt at a temperature equal to or higher than the melting point of the phosphors, and thus has high crystallinity. That is, the small-gap phosphor plate has less defects. Consequently, the temperature characteristic of the small-gap phosphor plate is improved, and thus, it is possible to suppress a decrease in the light emission efficiency caused by temperature rise.

As the light emitting portion 12A, a component other than the small-gap phosphor plate such as a monocrystalline phosphor plate and a polycrystalline phosphor plate may be used. For example, as the light emitting portion 12, a sealing material in which phosphors are dispersed may be used.

In this case, the sealing material of the light emitting portion 12 is, for example, a glass material (inorganic glass, organic-inorganic hybrid glass) or a resin material such as a silicone resin. Low melting point glass may be used as the glass material. The sealing material preferably has high transparency and preferably has high heat resistance in the case in which the laser light has high output power.

A type of the phosphors included in the light emitting portion 12 is selected, as appropriate, depending on the wavelength of the laser light to be irradiated with. Ce may be doped to increase laser light absorption efficiency of the light emitting portion 12. Specifically, as the light emitting portion 12, for example, a monocrystalline phosphor-plate or a polycrystalline phosphor plate based on YAG:Ce (cerium-doped yttrium aluminum garnet, yellow), GAGG:Ce (cerium-doped gadolinium, aluminum garnet, yellow), or LuAG:Ce (cerium-doped lutetium aluminum garnet, green) is preferably used.

<Excitation-Light Transmitting Film 13>

The excitation-light transmitting film 13 is an optical filter that transmits laser light and reflects fluorescent light. In the present embodiment, the excitation-light transmitting film 13 is formed of a dielectric multilayer film (for example, dielectric multilayer film or dichroic filter of SiO₂—TiO₂). The dielectric multilayer film is formed by a typical film-forming method. For example, a magnetron sputtering method is employed to produce a dielectric multilayer film by alternately stacking SiO₂ films and TiO₂ films. It is possible to change the optical characteristic of the excitation-light transmitting film 13, as appropriate, by changing the thickness or the type of each film of the dielectric multilayer film. For example, the structure of the SiO₂ films and the TiO₂ films is selected, as appropriate, within the ranges stated below.

Individual film thickness: several tens to several hundreds nanometers

Total number of stacked layers: 10 to 100

The excitation-light transmitting film 13 is provided directly on the light reception surface 12a of the light emitting portion 12.

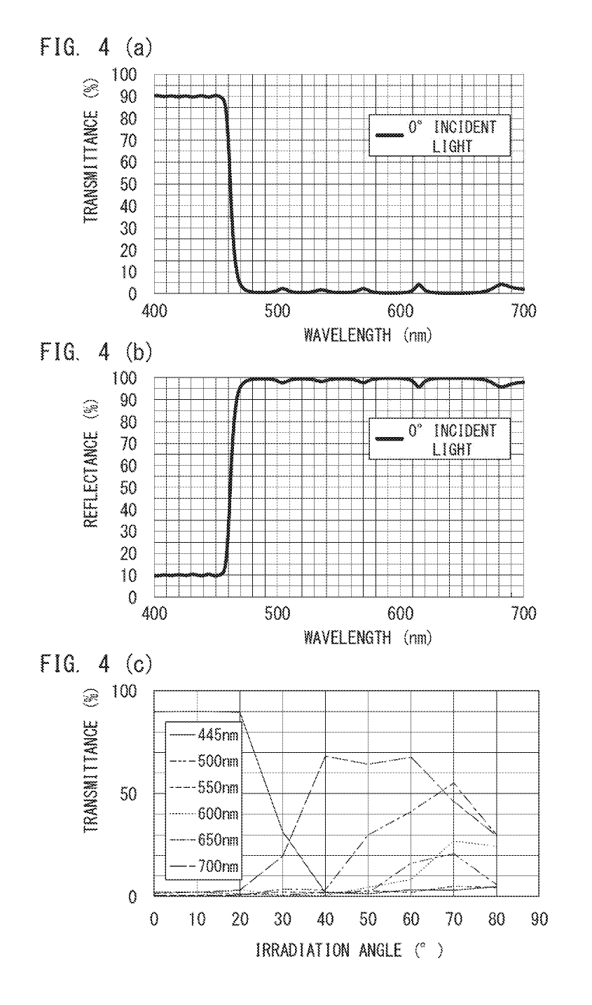

FIG. 4(a) is a graph showing a simulation result of the transmittance of light vertically incident on the excitation-light transmitting film 13. FIG. 4(b) is a graph showing a simulation result of the reflectance of light vertically incident on the excitation-light transmitting film 13. In each of FIGS. 4(a) and 4(b), the horizontal axis indicates the wavelength of the light, and the vertical axis indicates the transmittance or the reflectance. In the present embodiment, the graph of the reflectance in FIG. 4(b) is constituted by values of “100—transmittance (graph in FIG. 4(a))”. Each of the graphs in FIGS. 4(a) and 4(b) is a graph in the case in which the incident angle of the light with respect to the incident surface is 0°.

As shown in FIG. 4(a), the light transmittance of the excitation-light transmitting film 13 is (i) approximately 90% for the light having a wavelength of less than 455 nm or (ii) substantially 0% for the light having a wavelength of 480 nm or more. In contrast, as shown in FIG. 4(b), the light reflectance of the excitation-light transmitting film 13 is (i) approximately 10% for the light having a wavelength of less than 455 nm. or (ii) substantially 100% for the light having a wavelength of 480 nm or more.

As described above, in the present embodiment, the wavelength of the laser light emitted from each laser element 11 is 420 nm or more and less than 455 nm; thus, the laser light is easily transmitted through the excitation-light transmitting film 13. In contrast, in the present embodiment, the peak wavelength of the fluorescent light emitted by the light emitting portion 12 is approximately 550 nm; thus, the fluorescent light is not easily transmitted through, the excitation-light transmitting film 13.

FIG. 4(c) is a graph showing, for each wavelength, a simulation result of the transmittance of light incident on the excitation-light transmitting film 13. The phrase “laser light is easily transmitted” used above in the description of the excitation-light transmitting film 13 means that the transmittance of light having a wavelength of 445 nm (including light having a peak wavelength substantially similar to the wavelength) is 90% or more with an irradiation angle of 20° or less, as shown in FIG. 4(c). In addition, the phrase “fluorescent light is not easily transmitted” used above in the description of the excitation-light transmitting film 13 means that with the irradiation angle of 80° or less, (i) the transmittance of light having a wavelength of 480 nm or more and 700 nm or less is less than 70% (that is, the reflectance is 30% or more) and (ii) the transmittance of, in particular, light having a wavelength of 550 nm or more and 600 nm or less is less than 25% (that is, the reflectance is 75% or more). In the present embodiment, the irradiation angle is an angle formed by an optical path of light incident on the incident surface (light reception surface) and the normal line of the incident surface (that is, an incident angle of the light incident on the incident surface).

<Fluorescent-Light Transmitting Film 14>

The fluorescent-light transmitting film 14 is a dielectric multilayer film that reflects laser light and transmits fluorescent light. The fluorescent-light transmitting film 14 is produced by alternately stacking SiO₂ films and TiO₂ films, similarly to the excitation-light transmitting film 13. For example, the structure of the SiO₂ films and the TiO₂ films is selected, as appropriate, within the ranges stated below.

Individual film thickness: several tens to several hundreds nanometers

Total number of stacked layers: 10 to 100

However, the individual film thickness is different from the individual film thickness of the SiO₂ films and the TiO₂ films that form the excitation-light transmitting film 13. The fluorescent-light transmitting film 14 is provided directly on the emission surface 12b of the light emitting portion 12.

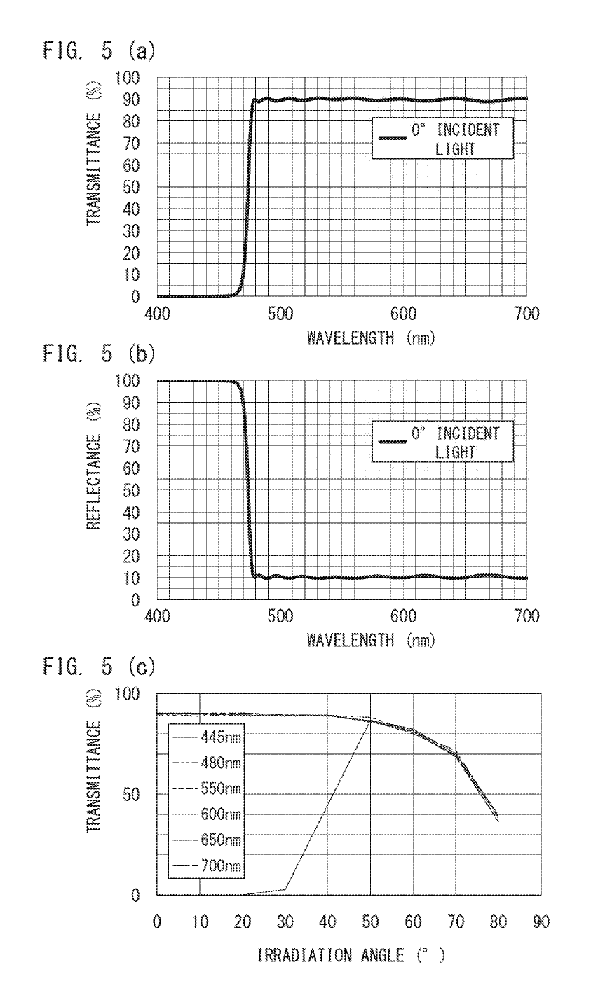

FIG. 5(a) is a graph showing a simulation result of the transmittance of light vertically incident on the fluorescent-light transmitting film 14. FIG. 5(b) is a graph showing a simulation result of the reflectance of light vertically incident on the fluorescent-light transmitting film 14. In each of FIGS. 5(a) and 5(b), the horizontal axis indicates the wavelength of the light, and the vertical axis indicates the transmittance or the reflectance. In the present embodiment, the graph of the reflectance in FIG. 5(b) is constituted by values of “100—transmittance (graph in FIG. 5(a))”. Each of the graphs in FIGS. 5(a) and 5(b) is a graph in the case in which the incident angle of the light with respect to the incident surface is 0°.

As shown in FIG. 5(a), the light transmittance of the fluorescent-light transmitting film 14 is (i) approximately 90% for the light having a wavelength of 480 nm or more or (ii) substantially 0% for the light having a wavelength of 460 nm or less. In contrast, the light reflectance of the fluorescent-light transmitting film 14 is (i) approximately 10% for the light having a wavelength of 480 nm or more or (ii) substantially 100% for the light having a wavelength of 460 nm or less.

As described above, in the present embodiment, the wavelength of the laser light emitted from each laser element 11 is 420 nm or more and less than 455 nm; thus, the laser light is not easily transmitted through the fluorescent-light transmitting film 14. In contrast, as described above, in the present embodiment, the peak wavelength of the fluorescent light emitted by the light emitting portion 12 is approximately 550 nm; thus, the fluorescent light is easily transmitted through the fluorescent-light transmitting film 14.

FIG. 5(c) is a graph showing, for each wavelength, a simulation result of the transmittance of light incident on the fluorescent-light transmitting film 14. The phrase “fluorescent light is easily transmitted” used above in the description of the fluorescent-light transmitting film 14 means that the transmittance of the light having a wavelength of 480 nm or more and 700 nm or less is 70% or more with an irradiation angle of 60° or less, as shown in FIG. 5(c). In addition, the phrase “laser light is not easily transmitted” used above in the description of the fluorescent-light transmitting film 14 means that the transmittance of the light having a wavelength of 445 nm (including light having a peak wavelength substantially similar to the wavelength) is 5% or less (that is, the reflectance is 95% or more) with an irradiation angle of 20° or less, as shown in FIG. 5(c).

<<Effects>>

To describe the effects of the light emitting device 10 according to the present embodiment, the behavior of laser light in the light emitting device 10 is compared with the behavior of laser light in a light emitting device of a comparative example. The light emitting device of the comparative example has the same configuration as that of the light emitting device 10 according to the present embodiment except that the excitation-light transmitting film 13 and the fluorescent-light transmitting film 14 are not included in the light emitting device of the comparative example.

(Behavior of Laser Light)

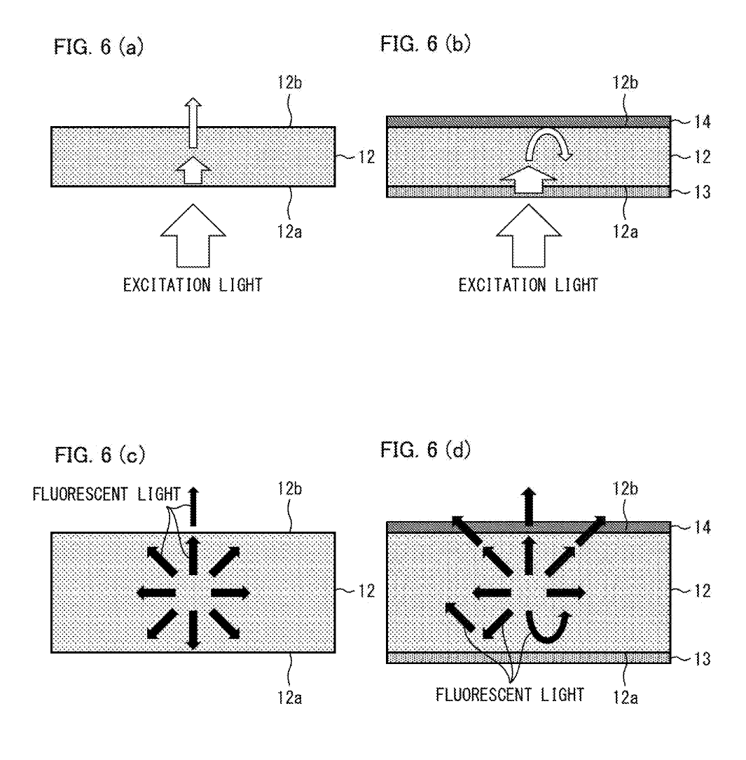

First, the behavior of laser light will be described. FIG. 6(a) is an illustration of the behavior of laser light in the light emitting device of the comparative example. In the light emitting device of the comparative example, as illustrated in FIG. 6(a), a portion of the laser light is reflected by the light reception surface 12a of the light emitting portion 12 and is not made incident (surface reflection loss) on the light emitting portion 12. A portion of the laser light that is made incident on the light emitting portion 12 is emitted from the emission surface 12b with the wavelength thereof not converted in the light emitting portion 12.

FIG. 6(b) is an illustration of the behavior of laser light in the light emitting device 10 according to the present embodiment. In the light emitting device 10 according to the present embodiment, the excitation-light transmitting film 13 is provided on the light reception surface 12a of the light emitting portion 12. Consequently, the incidence efficiency of the laser light with respect to the light emitting portion 12 is increased; as a result, the surface reflection loss on the light reception surface 12a is reduced, which increases the amount of laser light that is made incident on the light emitting portion 12 and thus increases the amount of fluorescent light.

In addition, in the light emitting device 10 according to the present embodiment, the fluorescent-light transmitting film 14 is provided on the emission surface 12b of the light emitting portion 12. Thus, at least a portion of the laser light having a wavelength that has not been converted before reaching the emission surface 12b from the light reception surface 12a returns to the inside of the light emitting portion 12, which enables reuse of the portion for emission of fluorescent light. Consequently, the excitation efficiency of the light emitting portion 12 is increased.

(Behavior of Fluorescent Light)

Next, the behavior of fluorescent light will be described. FIG. 6(c) is an illustration of the behavior of fluorescent light in the light emitting device of the comparative example. As described above, in the small-gap fluorescent member, the width of each gap is one-tenth or less of visible light. Thus, in the small-gap fluorescent member, Mie scattering of excitation light and fluorescent light hardly occurs.

For example, the haze value (ratio of the diffusion transmittance with respect to the total light transmittance of light) of the small-gap fluorescent member that has a flat surface is 4.6% when the small-gap fluorescent member is polycrystalline or 4.5% when the small-gap fluorescent member is polycrystalline. Each of the polycrystalline small-gap fluorescent member and the monocrystalline small-gap fluorescent member thus has an extremely low haze value, which is approximately 5% or less. In other words, the small-gap fluorescent member has extremely low light scattering properties. Accordingly, the light emitting portion 12 that is formed of the small-gap fluorescent member may be considered to be a member that has extremely low scattering properties and that hardly scatters light.

Thus, as illustrated in FIG. 6(c), the fluorescent light emitted in all directions from the light emitting portion 12 travels in the all directions as it is. In the light emitting device of the comparative example, fluorescent light that travels in directions other than forward (light emission direction of the light emitting device) is totally lost, and thus, the amount of fluorescent light emitted in a desired direction is decreased.

A portion of the fluorescent light that travels forward is reflected by the emission surface 12b and lost as a surface reflection loss. In particular, the emission surface 12b of the light emitting device of the comparative example is the interface between air (refractive index 1) and YAG phosphors (refractive index 1.9). Thus, of the fluorescent light that travels forward, fluorescent light having an irradiation angle with respect to the emission surface 12b of 32° or more is totally reflected. The irradiation angle of the totally-reflected fluorescent light varies depending on the combination of the refractive index of the phosphors that form the light emitting portion 12 and the refractive index of substances in contact with the emission surface 12b.

FIG. 6(d) is an illustration of the behavior of fluorescent light in the light emitting device 10 according to the present embodiment. As described above, in the light emitting device 10 according to the present embodiment, the provision of the excitation-light transmitting film 13 on the light reception surface 12a of the light emitting portion 12 enables a change in the traveling direction of the fluorescent light that has travelled inside the light emitting portion 12 toward the light reception surface 12a to a direction toward the emission surface 12b.

Moreover, in the light emitting device 10 according to the present embodiment, the fluorescent-light transmitting film 14 is provided on the emission surface 12b of the light emitting portion 12. Thus, the fluorescent light emitted forward from the light emitting portion 12 is not easily totally reflected by the emission surface 12b. Consequently, in the light emitting device 10, it is possible to increase efficiency of extracting fluorescent light from the emission surface 12b. Fluorescent light having an irradiation angle of 32° or more is totally reflected in the light emitting device of the comparative example; however, in the light emitting device 10, at least a portion of such fluorescent light is emitted from the emission surface 12b without being totally reflected.

As described above, according to the light emitting device 10 of the present embodiment, it is possible to increase the amount of fluorescent light generated in the light emitting portion 12 and to increase the amount of fluorescent light emitted from the emission surface 12b. Therefore, according to the light emitting device 10 of the present embodiment, it is possible to improve efficiency of extracting the fluorescent light in a desired direction when the small-gap fluorescent member is used as the light emitting portion 12. The light emitting device 10 according to the present embodiment is, for example, a light emitting device capable of being used as a light source for a projector apparatus. The light emitting device 10 according to the present embodiment may be used as a light source for a spotlight, a vehicle headlight, or the like.

Moreover, according to the illuminating apparatus 1 of the present embodiment, it is possible to provide an illuminating apparatus that has improved efficiency of extracting fluorescent light in a desired direction when the small-gap fluorescent member is used as the light emitting portion 12. The illuminating apparatus 1 according to the present embodiment is, for example, an illuminating apparatus capable of being used as a projector apparatus. The illuminating apparatus 1 according to the present embodiment may be used as a spotlight, a vehicle headlight, or the like.

In particular, in the case in which the small-gap fluorescent member is formed of monocrystalline phosphors, no Mie scattering occurs inside the small-gap fluorescent member. Thus, in the light emitting device of the comparative example, there noticeably appears a problem in which the amount of the fluorescent light emitted in a desired direction from the small-gap fluorescent member is decreased. Provided with the excitation-light transmitting film 13 and the fluorescent-light transmitting film 14, the light emitting device 10 according to the present embodiment is capable of solving the aforementioned noticeable problem in the case in which the light emitting portion 12 is formed of monocrystalline phosphors.

In addition, as described with reference to FIG. 6(b), the laser-light absorptivity of the light emitting portion 12 is improved. Thus, a less thickness is required for the light emitting portion 12 to generate a desired amount of fluorescent light, which enables the light emitting portion 12 to nave a thin shape. Consequently, when the light emitting portion 12 is used by being stuck onto a fixing jig or the like, as in a sixth embodiment described later, the heat generated in the light emitting portion 12 easily escapes to the fixing jig. As a result, the heat dissipation efficiency of the light emitting portion 12 is further improved, and thus, it is possible to reduce the temperature of the light emitting portion 12. Therefore, it is possible to improve the light emission efficiency of the light emitting portion 12.

In particular, when the monocrystalline small-gap phosphor plate is used as the light emitting portion 12, it is not possible to increase the concentration of Ce that is doped in the light emitting portion 12, and thus, it is not possible to increase the laser light absorption efficiency of the light emitting portion 12. Thus, when a desired amount of fluorescent light is caused to generate in the light emitting device of the comparative example, the thickness of the light emitting portion 12 is 500 μm or more. The significance of enabling the light emitting portion 12 to have a thin shape is noticeable in such a case.

(Advantages of Providing Fluorescent-Light Transmitting Film 14 Directly on Light Emitting Portion 12)

In the light emitting device 10, the fluorescent-light transmitting film 14 is provided directly on the emission surface 12b of the light emitting portion 12. Advantages thereof will be described below.

In general, a difference in the refractive index between air and each of various members (phosphors, resins, and the like) is larger than a difference in the refractive index between the various members. A surface reflection loss or total reflection that occurs on an interface results from a difference in the refractive index between two mediums that form the interface. Namely, for suppressing a surface reflection loss or total reflection, it is preferable that a difference in the refractive index between two mediums on which a light is made incident is small, and it is preferable, in particular, that one of the two mediums is not air.

When air is interposed between the emission surface 12b and the fluorescent-light transmitting film 14, fluorescent light having an irradiation angle with respect to the emission surface 12b of 32° or more is totally reflected by the emission surface 12b and is propagated inside the light emitting portion 12, similarly to the behavior of the fluorescent light in the light emitting device of the comparative example, which is described with reference to FIG. 6(c).

In contrast, in the light emitting device 10 according to the present embodiment, the fluorescent-light transmitting film 14 is provided directly on the emission surface 12b, and no air is interposed between the light emitting portion 12 and the fluorescent-light transmitting film 14.

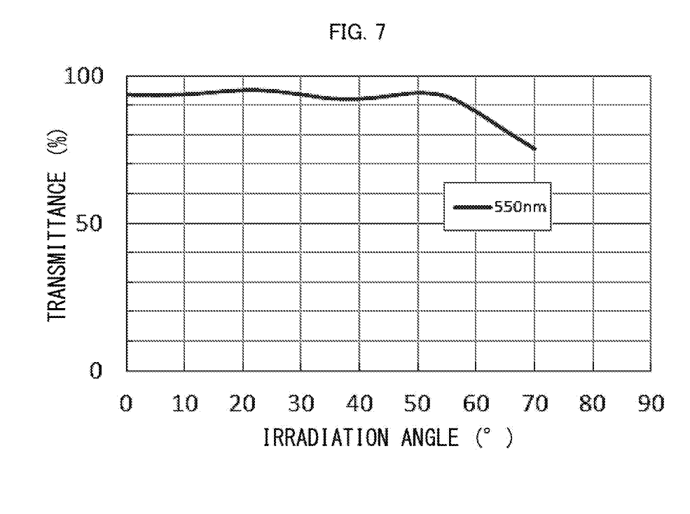

FIG. 7 is a graph showing the fluorescent-light transmittance of the emission surface 12b of the light emitting portion 12. In the graph in FIG. 7, the horizontal axis indicates the irradiation angle of fluorescent light with respect to the emission surface 12b, and the vertical axis indicates the fluorescent-light transmittance of the emission surface 12b. FIG. 7 shows the reflectance of the fluorescent light having a wavelength of 550 nm. As shown in FIG. 7, the transmittance of the fluorescent light in the light emitting device 10 is 90% or more even when the irradiation angle with respect to the emission surface 12b is in the range from 32° to 58°.

As described above, according to the light emitting device 10, it is possible to suppress a surface reflection loss and total reflection of fluorescent light on the emission surface 12b and to increase the amount (light emission amount) of fluorescent light emitted from the light emitting portion 12.

(Advantages of Providing Excitation-Light Transmitting Film 13 Directly on Light Emitting Portion 12)

In addition, in the light emitting device 10, the excitation-light transmitting film 13 is provided directly on the light reception surface 12a of the light emitting portion 12. Advantages thereof will be described below,

As described above, for suppressing a surface reflection loss and total reflection, it is preferable that a difference in the refractive index between two mediums on which a light is made incident is small, and it is preferable, in particular, that one of the two mediums is not air.

In the light emitting device 10, the excitation-light transmitting film 13 is provided directly on the light reception surface 12a. Thus, no air is interposed between the light emitting portion 12 and the excitation-light transmitting film 13. Consequently, compared with the case in which air is interposed, a surface reflection loss of laser light is suppressed at least on the light reception surface 12a, and thus, it is possible to increase the amount of the laser light incident on the light emitting portion 12. Therefore, it is possible to increase the emission amount of fluorescent light.

(Advantages of Characteristics of Dielectric Multilayer Film Used in the Present Embodiment)

In the light emitting device 10 according to the present embodiment, as described above, the excitation-light transmitting film 13 has characteristics in which with an irradiation angle of 80° or less, (i) the transmittance of the light having a wavelength of 480 nm or more and 700 nm or less is less than 70% (that is, the reflectance is 30% or more), and (ii) the transmittance of the light having a wavelength of 550 nm or more and 600 nm or less is less than 25% (that is, the reflectance is 75% or more). The fluorescent-light transmitting film 14 has characteristics in which with an irradiation angle of 60° or less, the transmittance of the light having a wavelength of 480 nm or more and 700 nm or less is 70% or more,

For example, in the illuminating apparatus in PTL 3, it is not possible to extract, of isotropically emitted fluorescent light, light that is totally reflected by an emission surface and an incident surface. In contrast, due to the provision of the excitation-light transmitting film 13 and the fluorescent-light transmitting film 14 that have the aforementioned characteristics, the light emitting device 10 according to the present embodiment is capable of suppressing generation of light that would be totally reflected in the illuminating apparatus in PTL 3. Therefore, it is possible to improve the fluorescent-light extraction efficiency compared with the illuminating apparatus in PTL 3.

Combining the excitation-light transmitting film 13 and the fluorescent-light transmitting film 14 that have the aforementioned characteristics with the light emitting portion 12 formed of the small-gap fluorescent member improves the resistance of the small-gap fluorescent member against neat or high-density laser light. Consequently, it is possible to further reduce an excitation-light irradiation size formed on the light reception surface 12a. Therefore, the light emitting device 10 is capable of providing a high-luminance light source. Moreover, according to the present configuration, it is possible to increase the absorptivity even when the small-gap fluorescent member, which makes it difficult to increase the concentration of an activator (activator in the present embodiment is Ce) and to increase the excitation-light absorptivity, is used as the light emitting portion. Consequently, as described above, the light emitting portion 12 is enabled to have a thin shape. The thin shape enables an improvement in the heat dissipation efficiency of the light emitting portion 12, leading to an increase in the light emission efficiency thereof. Such a combined configuration is not disclosed in PTLs 1 to 3; thus, the effect exhibited by the configuration is a noticeable effect that is not exhibited by the inventions described in respective PTLs 1 to 3.

Moreover, when a metal thin film (for example, a thin film formed of aluminum) having a thickness that enables transmission of excitation light or fluorescent light is used as each of the excitation-light transmitting film 13 and the fluorescent-light transmitting film 14, the excitation light or the fluorescent light that is totally reflected by the metal thin film is totally reflected again by the metal thin film. In this case, every time when total reflection is repeated, each metal thin film absorbs light, and thus, there is a possibility that the fluorescent-light extraction efficiency of each metal thin film is decreased. In contrast, the light emitting device 10 according to the present embodiment is capable, because the dielectric multilayer film having the aforementioned characteristics is used, of reducing the amount of the excitation light or the fluorescent light that is totally reflected. Therefore, in the light emitting device 10, it is possible to suppress a decrease in the fluorescent-light extraction efficiency.

### Second Embodiment

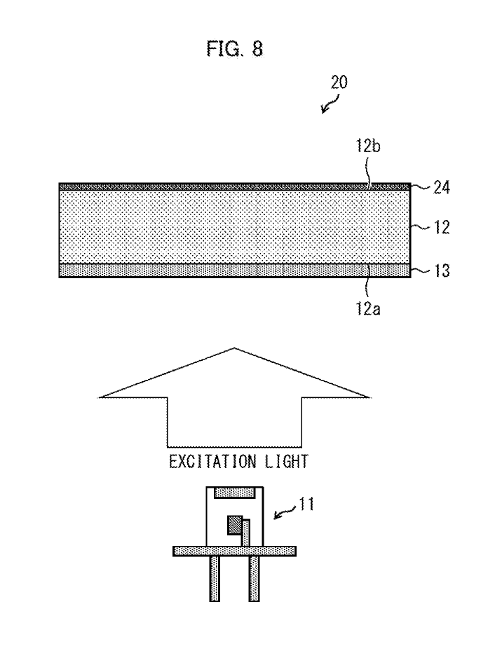

Another embodiment of the present invention will be described below with reference to FIG. 8. A light emitting device 20 according to the present embodiment includes a fluorescent-light transmitting thin film 24 (fluorescent-light transmitting member) in which the number of stacked layers of the dielectric multilayer films is different from that in the fluorescent-light transmitting film 14. Incidentally, for convenience of description, each component that has the same functions as those of the components described in the first embodiment is given the same reference sign, and description thereof will be omitted.

<<Light Emitting Device 20>>

FIG. 8 is a schematic view of a structure of the light emitting device 20 according to the present embodiment. As illustrated in FIG. 8, the light emitting device 20 includes laser elements 11, a light emitting portion 12, an excitation-light transmitting film 13, and a fluorescent-light transmitting thin film 24.

<Fluorescent-Light Transmitting Thin Film 24>

The fluorescent-light transmitting thin film 24 easily transmits fluorescent light, as does the fluorescent-light transmitting film 14. In addition, the fluorescent-light transmitting thin film 24 has high laser-light transmittance compared with the fluorescent-light transmitting film 14. Thus, the fluorescent-light transmitting film 14 reflects only a portion of laser light and transmits fluorescent light. Namely, the fluorescent-light transmitting film 14 reflects only a portion of laser light and transmits other portion of the laser light.

The fluorescent-light transmitting thin film 24 is formed by stacking SiO₂ films and TiO₂ films, as is the fluorescent-light transmitting film 14. The thickness of each SiO₂ film and the thickness of each TiO₂ film in the fluorescent-light transmitting thin film 24 are the same as those in the fluorescent-light transmitting film 14. In contrast, the number of the SiO₂ films and the number of the TiO₂ films are smaller than the number of the SiO₂ films and the number of the TiO₂ films, respectively, in the fluorescent-light transmitting film 14. Consequently, the laser-light transmittance of the fluorescent-light transmitting thin film 24 is higher than the laser-light transmittance of the fluorescent-light transmitting film 14. Specific number of stacked layers of each of the SiO₂ films and the TiO₂ films is determined, as appropriate, depending on desired laser-light transmittance.

<<Effects>>

In the light emitting device 20, a portion of the laser light is transmitted through the fluorescent-light transmitting thin film 24. Thus, it is possible to utilize, as emission light, light in which the laser light from each laser element 11 and fluorescent light from the light emitting portion 12 are mixed together.

In particular, when the light emitting device 20 is used as a light source for a projector apparatus, it is possible to emit laser light and fluorescent light from a single device, that is, the light emitting device 20. Thus, the projector apparatus is not required to include light sources that emit light of respective colors of R (red), G (green), and B (blue). Consequently, a reduction in the size of the projector apparatus is enabled.

A typical projector apparatus includes, for example, light sources of three colors of R (red), G (green), and B (blue) or light sources of five colors of R, G, B, Y (yellow), and W (white). When the light emitting device 20 in which the light emitting portion 12 is formed of YAG or GAGG and laser light is blue is used as a light source for a projector apparatus, the light emitting device 20 is capable of functioning as a light source that emits B (laser light), Y (fluorescent light), and W (mixture of B and Y). When the light emitting device 20 in which the light emitting portion 12 is formed of LuAG is used as a light source for a projector apparatus, the light emitting device 20 is capable of functioning as a light source that emits G (fluorescent light) and B (laser light). Moreover, the light emitting device 20, which is capable of emitting W, is usable as a light source for a spotlight or a vehicle headlight.

### Third Embodiment

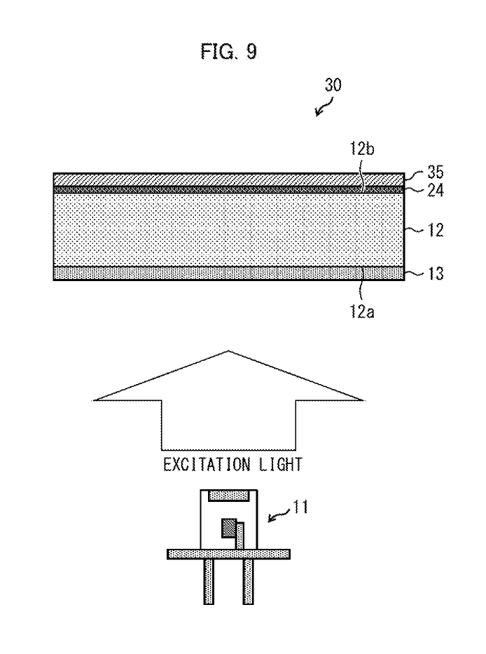

Another embodiment of the present invention will be described below with reference to FIG. 9. A light emitting device 30 according to the present embodiment includes a phosphor film (phosphor part) 35 in addition to the configuration of the light emitting device 20 described in the second embodiment.

<<Light Emitting Device 30>>

FIG. 9 is a schematic view of a structure of the light emitting device 30 according to the present embodiment. As illustrated in FIG. 9, the light emitting device 30 includes laser elements 11, a light emitting portion 12, an excitation-light transmitting film 13, a fluorescent-light transmitting thin film 24, and the phosphor film 35.

<Phosphor Film 35>

The phosphor film 35 emits fluorescent light having a color different from that of the fluorescent light emitted by the light emitting portion 12 that is irradiated with laser light. The phosphor film 35 is provided on a side of the light emitting portion 12 where the emission surface 12b is present. Specifically, the phosphor film 35 is provided on a surface of the fluorescent-light transmitting thin film 24, the surface being not in contact with the light emitting portion 12.

The phosphor film 35 is a deposited film formed by depositing phosphor particles on the fluorescent-light transmitting thin film 24. Candidates for a material that forms the phosphor film 35 are, for example, α-SiAlON (orange), sCASN (SrCaAlSiN, orange), or CASN (CaAlSiN, red). When the light emitting portion 12 is formed of a small-gap fluorescent member of phosphors, such as YAG and GAGG, that emit yellow fluorescent light, LuAG is also a candidate for the material that forms the phosphor film 35.

The phosphor film 35 may contain a plurality of types of phosphor particles. In this case, the phosphor film 35 may be a mixture deposited film of a plurality of types of phosphor particles. The phosphor film 35 may have a structure in which the phosphor particles form. layers that are different by each type of the phosphor particles. In the latter case, it is preferable that a phosphor layer that emits fluorescent light having a shorter wavelength is separated further from the fluorescent-light transmitting thin film 24.

The phosphor film 35 may be a small-gap fluorescent member as is the light emitting portion 12. The phosphor film 35 may be provided between the light emitting portion 12 and the fluorescent-light transmitting thin film 24.

<<Effects>>

As described in the second embodiment, the fluorescent-light transmitting thin film 24 transmits a portion of laser light. In the light emitting device 30, the portion of the laser light transmitted through the fluorescent-light transmitting thin film 24 is absorbed by the phosphor film 35, and fluorescent light is emitted. Therefore, the light emitting device 30 emits laser light and a plurality of colors of fluorescent light, and thus, it is possible to increase types of the color of light emitted from the light emitting device 30.

Consequently, when the light emitting device 30 is used as a light source for a projector apparatus, it is possible to reduce the number of light sources provided in the projector apparatus and to reduce the size of the projector apparatus.

When the light emitting portion 12 is formed of YAG or GAGG, and the phosphor film 35 contains CASN, the light emitting device 30 is capable of emitting R (fluorescent light from CASN), B (laser light), Y (fluorescent light from the light emitting portion 12), and W (mixture of B and Y). Moreover, when the phosphor film 35 further contains LuAG, the light emitting device 30 is capable of emitting G (fluorescent light from LuAG) in addition to the aforementioned R, B, Y, and W. In addition, the provision of the phosphor film 35 improves the color rendering properties of the light emitting device 30. Thus, it is possible to provide a spotlight or a vehicle headlight having excellent color rendering properties by employing the light emitting device 30 as a light source.

When the light emitting portion 12 is formed of LuAG, the light emitting device 30 is capable of emitting R (fluorescent light from the phosphor film 35), G (fluorescent light from LuAG), B (laser light), and W (mixture of R, G, and B). Moreover, the provision of the phosphor film 35 improves the color rendering properties of the light emitting device 30.

### Fourth Embodiment

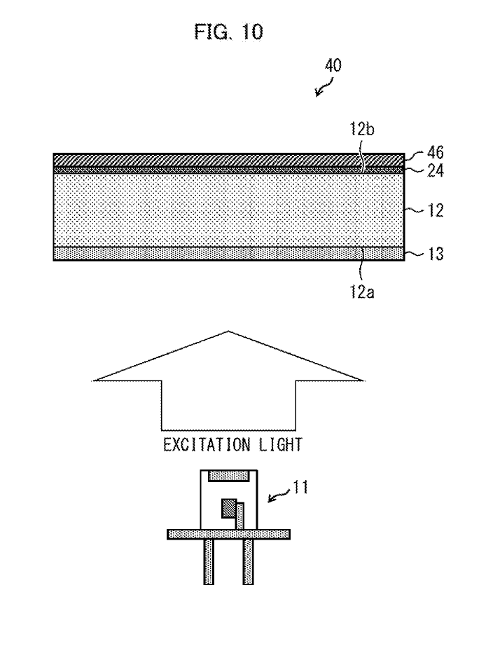

Another embodiment of the present invention will be described below with reference to FIG. 10. A light emitting device 40 according to the present embodiment includes a scattering layer (scattering member) 46 in addition to the configuration of the light emitting device 20 described in the second embodiment.

<<Light Emitting Device 40>>

FIG. 10 is a schematic view of a configuration of the light emitting device 40 according to the present embodiment. As illustrated in FIG. 10, the light emitting device 40 includes laser elements 11, a light emitting portion 12, an excitation-light transmitting film 13, a fluorescent-light transmitting thin film 24, and the scattering layer (scattering member) 46.

<Scattering Layer 46>

The scattering layer 46 scatters light, in particular, laser light, that is emitted by being transmitted through the fluorescent-light transmitting thin film 24. The scattering layer 46 is provided on the side of the light emitting portion 12 where the emission surface 12b is present. Specifically, the scattering layer 46 is provided on a surface of the fluorescent-light transmitting thin film 24, the surface being not in contact with the light emitting portion 12.

The scattering layer 46 may be an uneven-shaped portion provided on the surface of the fluorescent-light transmitting thin film 24 or may be a film that is formed by depositing particles of alumina or the like on the surface of the fluorescent-light transmitting thin film 24. Moreover, the scattering layer 46 may be a film in which particles of alumina or the like are sealed in a silicone resin, an acrylic resin, or the like.

The scattering layer 46 may be provided in the light emitting device 30. In this case, the scattering layer 46 is provided on a surface of the phosphor film 35 of the light emitting device 30, the surface being not in contact with the fluorescent-light transmitting thin film 24.

<<Effects>>

When light that is formed by mixing together excitation light and fluorescent light is used for illumination, the light distribution characteristic of the excitation light and the light distribution characteristic of the fluorescent light are required to match each other. As described above, the fluorescent light emitted in all directions from the small-gap phosphor plate travels in the all directions as it is. That is, the fluorescent light emitted by the light emitting portion 12 has a light distribution characteristic such that the fluorescent light travels toward an extremely wide area. In contrast, when the excitation light is, in particular, laser light, the excitation light has a light distribution characteristic such that the excitation light travels toward an extremely narrow area. Consequently, when the excitation light is transmitted through the light emitting portion 12 as it is, the light distribution characteristic of the fluorescent light and the light distribution characteristic of the excitation light do not match each other, and there is a possibility of generating color unevenness of the light emitted from the fluorescent-light transmitting film 14.

The light emitting device 40 according to the present embodiment is capable of widening the light distribution characteristic of the laser light by using the scattering layer 46 so that the light distribution characteristic of the laser light becomes similar to the light distribution characteristic of the fluorescent light. Consequently, the light distribution characteristic of the laser light and the light distribution characteristic of the fluorescent light match each other. Therefore, according to the light emitting device 40, it is possible to provide, in addition to the effects of the light emitting device 20 described in the second embodiment, a light emitting device that has less color unevenness of emission light.

An illuminating apparatus provided with the light emitting device according to the present embodiment is suitable, in particular, for use as a spotlight, a vehicle headlight, and the like.

### Fifth Embodiment

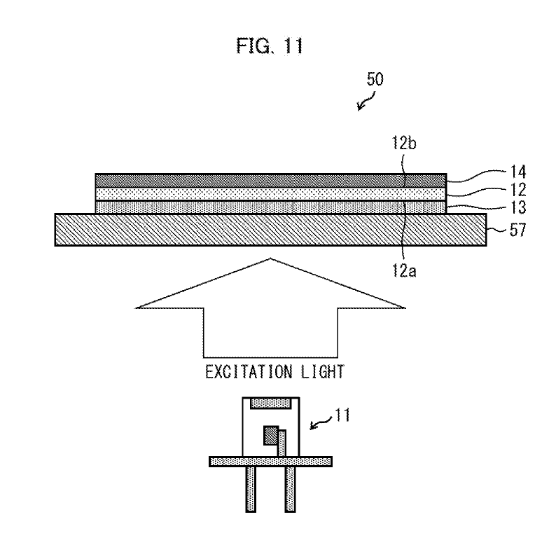

Another embodiment of the present invention will be described with reference to FIG. 11.

<<Light Emitting Device 50>>

FIG. 11 is a schematic view illustrating a configuration of a light emitting device 50 according to the present embodiment. As illustrated in. FIG. 11, the light emitting device 50 includes laser elements 11, a light emitting portion 12, an excitation-light transmitting film 13, a fluorescent-light transmitting film 14, and a holding substrate 57.

The holding substrate 57 holds the light emitting portion 12. The holding substrate 57 is provided on a side of the light emitting portion 12 where the light reception surface 12a is present. Specifically, the holding substrate 57 holds the light emitting portion 12 via the excitation-light transmitting film 13. The holding substrate 57 preferably has high laser-light transmittance and is formed of, for example, sapphire.

In addition, the holding substrate 57 preferably has a function of dissipating the heat generated in the light emitting portion 12. In this case, a material that is high in terms of both the transmittance and the heat conductivity is used in the holding substrate 57. Moreover, a portion of the holding substrate 57 on which the excitation-light transmitting film 13 is provided may be formed of a material having high transmittance, and other portion thereof may be formed of a material having high heat conductivity.

<<Effects>>

The provision of the excitation-light transmitting film 13 and the fluorescent-light transmitting film 14 on the light emitting portion 12 enables the light emitting portion 12 to have a thin shape. In this case, propagation of fluorescent light inside the light emitting portion 12 is suppressed, which causes the fluorescent light to be easily-emitted from the emission surface 12b. However, when the thickness of the light emitting portion 12 is 20 μm or less, there is a possibility that the light emitting portion 12 in such a state is unsuitable for practical use because the strength of the light emitting portion 12 is decreased.

The light emitting device 50 according to the present embodiment is capable of holding the light emitting portion 12 by the holding substrate 57. Consequently, according to the light emitting device 50, it is possible to use the light emitting portion 12 that is comparatively thin. In this case, propagation of fluorescent light inside the light emitting portion 12 is suppressed, which enables the fluorescent light to be more easily extracted from the emission surface 12b.

### Sixth Embodiment

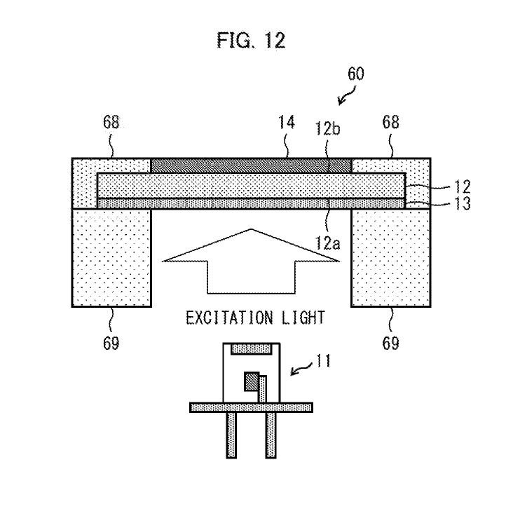

Another embodiment of the present invention will be described below with reference to FIG. 12.

<<Light Emitting Device 60>>

FIG. 12 is a schematic view illustrating a configuration of a light emitting device 60 according to the present embodiment. As illustrated in FIG. 12, the light emitting device 60 includes laser elements 11, a light emitting portion 12, an excitation-light transmitting film 13, a fluorescent-light transmitting film 14, a first fixing jig (holding member) 68, and a second fixing jig (holding member) 69.

The first fixing jig 68 and the second fixing jig 69 constitute a holding member that holds the light emitting portion 12. In addition, each of the first fixing jig 68 and the second fixing jig 69 functions as a heat dissipation member that diffuses the heat generated in the light emitting portion 12. The first fixing jig 68 and the second fixing jig 69 are formed of, for example, aluminum, copper, or black anodized aluminum.

<<Effects>>

As described above, the light emitting device 60 according to the present embodiment is held by the first fixing jig 68 and the second fixing jig 69. Each of the first fixing jig 68 and the second fixing jig 69 is formed of a material that has high heat conductivity. Consequently, the heat generated in the light emitting portion 12 is diffused by the first fixing jig 68 and the second fixing jig 69. Therefore, it is possible to suppress deterioration of the light emitting portion 12.

### Modifications

In each of the aforementioned embodiments, both the excitation-light transmitting film 13 and the fluorescent-light transmitting film 14 are provided directly on the light emitting portion 12. However, the excitation-light transmitting film 13 and the fluorescent-light transmitting film 14 are not necessarily directly provided on (directly attached to) the light emitting portion 12. A film that is formed of a material having a refractive index substantially similar to the refractive index of the light emitting portion 12 may be provided between the light emitting portion 12 and the excitation-light transmitting film 13 and/or between the light emitting portion 12 and the fluorescent-light transmitting film 14. Even when such a film is provided, it is possible to avoid interposition of air, which has a refractive index greatly different from that of the light emitting portion 12, between the light emitting portion 12 and the excitation-light transmitting film 13 and between the light emitting portion 12 and the fluorescent-light transmitting film 14. As a result, it is possible to suppress a surface reflection loss or total reflection on the light reception surface 12a or the emission surface 12b of the light emitting portion 12.

### Summary

A light emitting device (10) according to a first aspect of the present invention includes a small-gap fluorescent member (light emitting portion 12) that emits fluorescent light by receiving excitation light emitted from excitation light sources (laser elements 11). The small-gap fluorescent member includes a gap present inside thereof. The gap has a width that is one-tenth or less of a wavelength of the excitation light. The small-gap fluorescent member has a light reception surface (12a) that receives the excitation light and an emission surface (12b) that is opposite to the light reception surface and that emits the fluorescent light. An excitation-light transmitting member (excitation-light transmitting film 13) that transmits the excitation light and that reflects the fluorescent light is provided on a side of the small-gap fluorescent member where the light reception surface is present. A fluorescent-light transmitting member (fluorescent-light transmitting film 14, fluorescent-light transmitting thin film 24) that reflects the excitation light and transmits the fluorescent light is provided on a side of the small-gap fluorescent member where the emission surface is present.

The light emitting device according to the first aspect includes, as a member that emits fluorescent light, the small-gap fluorescent member in which the gap has the aforementioned width. When such a small-gap fluorescent member is irradiated with light, Mie scattering hardly occurs inside thereof. Thus, the fluorescent light emitted in all directions inside the small-gap fluorescent member travels in the all directions as it is, and there is a possibility that the amount of the fluorescent light emitted in a desired direction from the small-gap fluorescent member is decreased.

According to the aforementioned configuration, as a result of providing the excitation-light transmitting member on the side where the light reception surface is present, it is possible to increase the incidence efficiency of the excitation light with respect to the small-gap fluorescent member and to change the travelling direction of the fluorescent light that travels inside the small-gap fluorescent member toward the light reception surface to a direction toward the emission surface.

In addition, the provision of the fluorescent-light transmitting member on the side where the emission surface is present causes the excitation light to return to the inside of the small-gap fluorescent member, which enables the excitation light to be reused for emission of fluorescent light. Consequently, the excitation efficiency of the small-gap fluorescent member is increased. In addition, efficiency of extracting the fluorescent light from the emission surface is increased.

Therefore, according to the aforementioned configuration, it is possible to increase the amount of the fluorescent light generated in the small-gap fluorescent member and to increase the amount of fluorescent light emitted from the emission surface. Accordingly, according to the light emitting device of the first aspect, it is possible to improve efficiency of extracting the fluorescent light in a desired direction when the small-gap fluorescent member is used.

In a light emitting device (20) according to a second aspect of the present invention, it is preferable that, in the first aspect, the fluorescent-light transmitting member (fluorescent-light transmitting thin film 24) reflects only a portion of the excitation light.

According to the aforementioned configuration, the fluorescent-light transmitting member reflects only a portion of the excitation light. Thus, it is possible to reuse the portion of the excitation light for emission of fluorescent light because the portion of the excitation light returns to the inside of the small-gap fluorescent member. Consequently, it is possible to increase the excitation efficiency of the small-gap fluorescent member. In addition, it is possible to increase efficiency of extracting the fluorescent light from the emission surface.

The fluorescent-light transmitting member reflects only a portion of the excitation light and thus is capable of transmitting the other portion of the excitation light and emitting the other portion to the outside of the light emitting device. That is, the light emitting device is capable of emitting, to the outside, light in which the excitation light and the fluorescent light are mixed together.

In a light emitting device according to a third aspect of the present invention, it is preferable that, in the first or second aspect, the small-gap fluorescent member is formed of monocrystalline phosphors.

According to the aforementioned configuration, Mie scattering does not occur inside the small-gap fluorescent member. Thus, there noticeably appears a problem in which the amount of the fluorescent light emitted in a desired direction from the small-gap fluorescent member is decreased. The light emitting device according to the present application is capable, because of the provision of the excitation-light transmitting member and the fluorescent-light transmitting member, of solving the aforementioned noticeable problem in the case in which the small-gap fluorescent member is formed of monocrystalline phosphors.

The heat conductivity of a small-gap phosphor formed of monocrystalline phosphors is high, and thus, the heat generated in the small-gap fluorescent member is enabled to easily escape. Consequently, it is possible to improve the conversion efficiency of the small-gap fluorescent member from the excitation light to the fluorescent light. Therefore, the small-gap fluorescent member is capable of outputting high-luminance light.

In a light emitting device (30) according to a fourth aspect of the present invention, it is preferable that, in any of the first to third aspects, there is further provided a phosphor part (phosphor film 35) on the side where the emission surface is present, the phosphor part emitting, by receiving the excitation light, fluorescent light that has a color different from that of the fluorescent light emitted by the small-gap fluorescent member.

According to the aforementioned configuration, it is possible to increase types of the color of the light emitted from the light emitting device.

In a light emitting device (40) according to a fifth aspect of the present invention, it is preferable that, in the second aspect, there is further provided a scattering member (scattering layer 46) on the side where the emission surface is present, the scattering member scattering the excitation light.

A portion of the excitation light transmitted through the small-gap fluorescent member is sometimes transmitted through the fluorescent-light transmitting member. In general, excitation light has a narrow light distribution characteristic, and fluorescent light has a wide light distribution characteristic. Thus, when excitation light is transmitted as it is through the fluorescent-light transmitting member, there is a possibility that color unevenness occurs in the light (that is, excitation light and fluorescent light) emitted from the fluorescent-light transmitting member.

According to the aforementioned configuration, it is possible to widen the light distribution characteristics of the excitation light transmitted through the fluorescent-light transmitting member because the scattering member is provided on the side where the emission surface is present. Therefore, it is possible to suppress occurrence of color unevenness. That is, it is possible to provide a light emitting device in which occurrence of color unevenness is suppressed.

In a light emitting device according to a sixth aspect of the present invention, it is preferable that, in any of the aforementioned first to fifth aspects, the fluorescent-light transmitting member is provided directly on the emission surface.

According to the aforementioned configuration, the fluorescent-light transmitting member is provided directly on the emission surface, and no air is interposed between the small-gap fluorescent member and the fluorescent-light transmitting member. Thus, it is possible to suppress occurrence of a surface reflection loss and total reflection of fluorescent light on the emission surface compared with the case in which air is interposed, and thus, it is possible to increase the amount of the fluorescent light emitted from the small-gap fluorescent member. Therefore, it is possible to increase the emission amount of the fluorescent light.

In a light emitting device according to a seventh aspect of the present invention, it is preferable that, in any of the aforementioned first to sixth aspects, the excitation-light transmitting member is provided directly on the light reception surface.

According to the aforementioned configuration, the excitation-light transmitting member is provided directly on the light reception surface, and no air is interposed between the small-gap fluorescent member and the excitation-light transmitting member. Thus, it is possible to suppress occurrence of a surface reflection loss of the excitation light at least on the light reception surface compared with the case in which air is interposed, and thus, it is possible to increase the amount of the excitation light incident on the small-gap fluorescent member. Therefore, it is possible to increase the emission amount of the fluorescent light.

In a light emitting device (50) according to an eighth aspect of the present invention, it is preferable that, in any of the aforementioned first to seventh aspects, there is further provided a holding substrate (57) that is provided on the side where the light reception surface is present and that holds the small-gap fluorescent member via the excitation-light transmitting member.

According to the aforementioned configuration, it is possible to hold the small-gap fluorescent member by the holding substrate, and thus, it is possible to use a comparative thin small-gap phosphor. In this case, propagation of the fluorescent light inside the small-gap fluorescent member is suppressed, which enables the fluorescent light to be more easily extracted from the emission surface.

In a light emitting device (60) according to a ninth aspect of the present invention, it is preferable that, in any of the aforementioned first to eighth aspects, there is further provided a holding member (first fixing jig 68, second fixing jig 69) that holds the small-gap fluorescent member, and that the holding member is a heat dissipation member that diffuses the heat generated in the small-gap fluorescent member.

According to the aforementioned configuration, it is possible to diffuse the heat generated in the small-gap fluorescent member, and thus, it is possible to suppress the deterioration of the small-gap fluorescent member.

In a light emitting device according to a tenth aspect of the present invention, it is preferable that, in any of the aforementioned first to ninth aspects, the excitation light source is a laser element (11) that emits laser light as the excitation light.

According to the aforementioned configuration, it is possible to provide a high-luminance light emitting device.

In an illuminating apparatus (1) according to an eleventh aspect of the present invention, it is preferable that there are provided the light emitting device according to any of the aforementioned first to tenth aspects; and a light-projecting member (light-projecting lens 8) that projects the fluorescent light emitted from the light emitting device.

According to the aforementioned configuration, it is possible to provide an illuminating apparatus in which the efficiency of extracting fluorescent light in a desired direction is improved.

The present invention is not limited to the aforementioned embodiments and may be variously modified within the scope disclosed in the claims. Moreover, embodiments that are obtained by combining together, as appropriate, the technical means that are disclosed in the different embodiments are also included in the technical scope of one aspect of the present invention. Furthermore, new technical features may be formed by combining together the technical means disclosed in the respective embodiments.

(Other Expression of the Present Invention)

One aspect of the present invention may be expressed as below.

Namely, the light emitting device according to one aspect of the present invention is a light emitting device in which a light emitting element and a small-gap phosphor plate are used. In the light emitting device, an excitation-light transmitting film is provided on a surface of the small-gap phosphor plate on which excitation light emitted by the light emitting element is incident, and a fluorescent-light transmitting film is provided on a surface of the small-gap phosphor plate opposite to the surface on which the excitation light emitted by the light emitting element is incident.

### REFERENCE SIGNS LIST

1 ILLUMINATING APPARATUS
8 LIGHT-PROJECTING LENS (LIGHT-PROJECTING MEMBER)
10, 20, 30, 40, 50, 60 LIGHT EMITTING DEVICE
11 LASER ELEMENT (EXCITATION LIGHT SOURCE)
12 LIGHT EMITTING PORTION (SMALL-GAP FLUORESCENT MEMBER)
12a LIGHT RECEPTION SURFACE
12b EMISSION SURFACE
13 EXCITATION-LIGHT TRANSMITTING FILM (EXCITATION-LIGHT TRANSMITTING MEMBER)
14 FLUORESCENT-LIGHT TRANSMITTING FILM (FLUORESCENT-LIGHT TRANSMITTING MEMBER
24 FLUORESCENT-LIGHT TRANSMITTING THIN FILM (FLUORESCENT-LIGHT TRANSMITTING MEMBER)
35 PHOSPHOR FILM (PHOSPHOR PART)
46 SCATTERING LAYER (SCATTERING MEMBER)
57 HOLDING SUBSTRATE
68 FIRST FIXING JIG (HOLDING MEMBER)
69 SECOND FIXING JIG (HOLDING MEMBER)

1. A light emitting device comprising:
a small-gap fluorescent member that emits fluorescent light by receiving excitation light emitted from an excitation light source,
wherein the small-gap fluorescent member includes
a gap present inside thereof, the gap having a width that is one-tenth or less of a wavelength of the excitation light, and
a light reception surface that receives the excitation light and an emission surface that is opposite to the light reception surface and that emits the fluorescent light,
wherein an excitation-light transmitting member is provided on a side where the light reception surface is present, the excitation-light transmitting member transmitting the excitation light and reflecting the fluorescent light,
wherein a fluorescent-light transmitting member is provided on a side where the emission surface is present, the fluorescent-light transmitting member reflecting the excitation light and transmitting the fluorescent light, and
wherein each of the excitation-light transmitting member and the fluorescent-light transmitting member is formed of a dielectric multilayer film,

2. The light emitting device according to claim 1, wherein the fluorescent-light transmitting member reflects only a portion of the excitation light.

3. The light emitting device according to claim 1, wherein the small-gap fluorescent member is formed of a monocrystalline phosphor.

4. The light emitting device according to claim 1, further comprising a phosphor part that is provided on the side where the emission surface is present, the phosphor part emitting, by receiving the excitation light, fluorescent light of a color different from a color of the fluorescent light emitted by the small-gap fluorescent member.

5. The light emitting device according to claim 2, further comprising a scattering member that is provided on the side where the emission surface is present, the scattering member scattering the excitation light,

6. An illuminating apparatus comprising:
the light emitting device according to claim 1; and
a light-projecting member that projects the fluorescent light emitted from the light emitting device.
